(19) United States
(12) Patent Application Publication
(10) Pub. No.: US 2008/0094479 A1
(43) Pub. Date: Apr. 24, 2008

(54) DETERMINATION OF STATE OF DIGITAL IMAGING DEVICE

(76) Inventors: Jason Yost, Windsor, CO (US); Daniel Bloom, Loveland, CO (US); Daniel G. Franke, Berthoud, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/550,844

(22) Filed: Oct. 19, 2006

(51) Int. Cl. H04N 5/228

(52) U.S. Cl. 348/208.99

(57) ABSTRACT

A method comprises determining whether a digital imaging device is in a stable state or an unstable state and causing an event to be performed upon the digital imaging device transitioning from the unstable state to the stable state. The method also comprises precluding the event from being performed while the digital imaging device is in the unstable state.

### BACKGROUND

Digital imaging devices such as digital cameras typically include some kind of automatic focus and exposure feature. The automatic focus and exposure feature of a digital imaging device unfortunately consumes battery power thereby reducing the imaging device's ability to take pictures. Further, in some situations such as when the camera is experiencing motion relative to the scene at which the camera is pointed, the digital imaging device's algorithm for performing automatic focus and exposure may not function satisfactorily.

### BRIEF DESCRIPTION OF THE DRAWINGS

For a detailed description of exemplary embodiments of the invention, reference will now be made to the accompanying drawings in which:

FIG. 1 is a block diagram of a digital imaging device in accordance with illustrative embodiments of the invention;

FIG. 2 is a block diagram of an imaging module of the digital imaging device shown in FIG. 1 in accordance with an illustrative embodiment of the invention;

FIG. 3 is a block diagram of image processing logic of the digital imaging device shown in FIG. 1 in accordance with an illustrative embodiment of the invention, and

FIG. 4 shows a flowchart of the operation of the digital imaging device of FIG. 1 in accordance with an illustrative embodiment of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. The term “connect” refers to a connection between two components without intervening components therebetween.

### DETAILED DESCRIPTION

The embodiments discussed herein are generally related to continuous focus and continuous exposure-based digital imaging and other types of devices that may be sensitive to scene stability. Scene stability refers to the relative motion, or lack thereof, of the imaging device to the scene being imaged. Such devices attempt to achieve proper focus and exposure on a continuous basis even if a user of the digital imaging device is not pressing the shutter button to take a picture. Various embodiments described herein dictate when the digital imaging device is permitted to perform a focus or exposure process. For example, if the digital imaging device is not stable (e.g., due to excessive motion of the imaging device relative to the scene being imaged), the imaging device precludes a focus or other type of stability-sensitive process from being performed. If the digital imaging device is stable, the process is permitted to be performed. If, while such a process is underway, the imaging device transitions from a stable state to a state of lower stability, the process is aborted. In some embodiments, the state of lower stability comprises a state whose stability is lower than the state in which the process is being performed. In some embodiments, the state of lower stability comprises an unstable state. Further, once the stability-sensitive process has been performed, the imaging device precludes the process from being performed again as long as the imaging device continues to be in the stable state. Any of a variety of other factors are considered as well when determining how to control the digital imaging device's ability to perform a stability-sensitive process. Such other factors include, for example, historical usage of the digital imaging device, a quality metric, etc. Further, different levels of stable states can spawn different stability-sensitive processes. These and other features are discussed below in greater detail.

The embodiments discussed herein are provided in the context of a digital imaging device. An example of a digital imaging device is a digital camera. The scope of this disclosure, however, is not limited to digital cameras and includes other types of digital imaging devices such as a digital camcorder having a still-picture camera mode or a cellular telephone with a built-in camera. In at least some embodiments, the digital imaging device is battery-powered and portable.

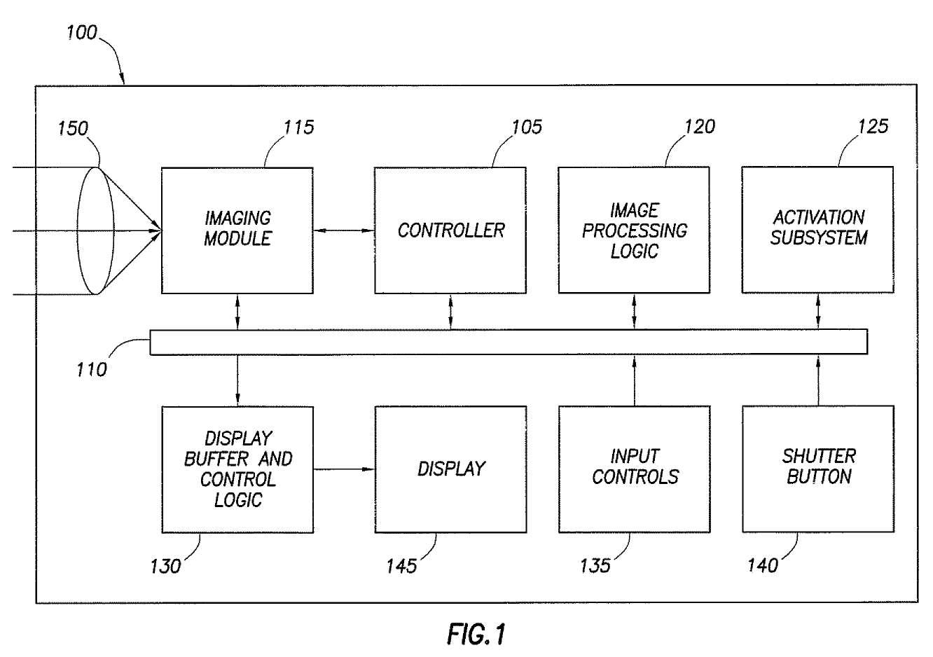

FIG. 1 is a functional block diagram of a digital imaging device 100 in accordance with an illustrative embodiment of the invention. In FIG. 1, a controller 105 communicates over data bus 110 with an imaging module 115, image processing logic 120, an activation subsystem 125, display buffer and control logic 130, input controls 135, and shutter button 140. Display buffer and control logic 130 is, in turn, connected to display 145. Display 145 may be, for example, a liquid crystal display (LCD). Optical system 150 produces optical images that are converted to digital image data (e.g., frames) by imaging module 115. Input controls 135 may comprise navigational buttons, an input control (e.g., a button or switch) to activate a continuous focus and exposure mode in digital imaging device 100, and other input controls to control the operation of digital imaging device 100. Shutter button 140 may have an intermediate position (S1) to manually effectuate a focus and exposure process and an image capture position (S2).

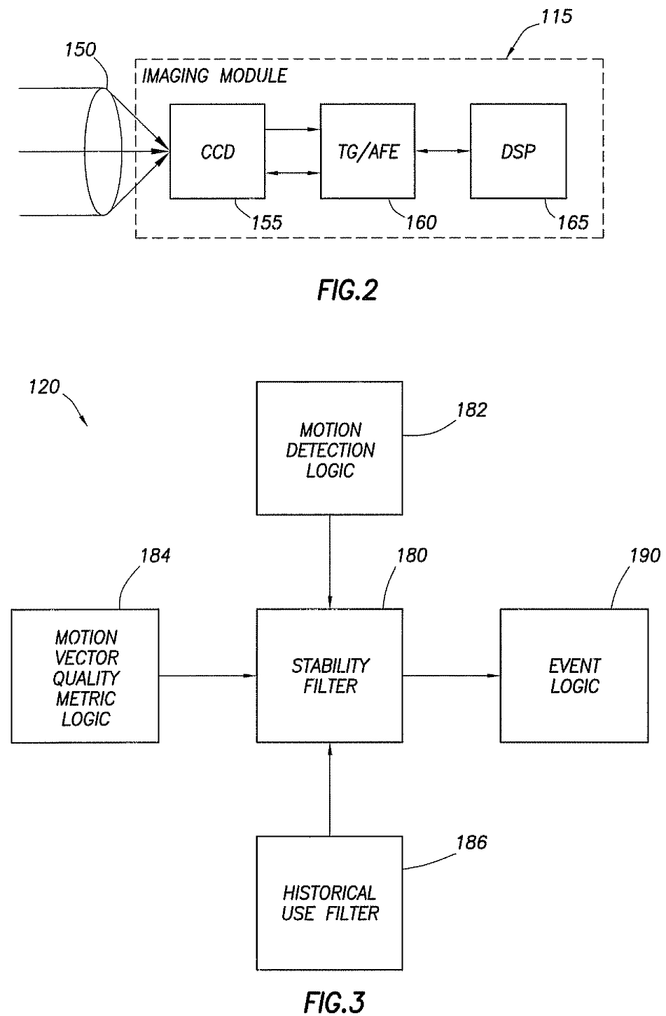

FIG. 2 is a functional block diagram of imaging module 115 in accordance with an illustrative embodiment of the invention. As shown, imaging module 115 comprises an imaging sensor 155 (in this example, a charge coupled detector (CCD) sensor array), a timing generator/analog front end (TG/AFE) 160, and a digital signal processor (DSP) 165. As indicated in FIG. 1, imaging module 115, via DSP 165, may communicate directly with controller 105 in some embodiments. As indicated in FIG. 2, both data and control signals connect imaging sensor 155 and TG/AFE 160.

FIG. 3 is a functional diagram of imaging processing logic 120 in accordance with an illustrative embodiment of the invention. As shown, image processing logic 120 comprises a stability filter 180, motion detection logic 182, motion vector quality metric logic 184, a historical use filter 186, and event logic 190. The stability filter 180 receives input from the motion detection logic 182, motion vector quality metric logic 184, and a historical use filter 186 and provides one or more signals to the event logic 190. The event logic 190 performs an event such as an auto-focus and/or and auto-exposure. The event logic 190 may perform other types of stability-sensitive processes as well as other types of processes. The stability filter 180 controls the operation of the event logic 190 as will be explained in detail below. In general, the stability filter 180 determines whether the digital imaging device 100 is in a stable state or unstable state and informs the event logic 190 accordingly.

As discussed previously, some processes (such as auto-focus and auto-exposure) are sensitive to motion of the digital imaging device 100 relative to the scene being imaged. The motion detection logic 182 processes digital image data from the imaging module 115 to determine whether and how much motion is being experienced by the digital imaging device 100. The digital imaging device's stability filter uses the motion information to determine whether the digital imaging device is in a stable or unstable state. Any of a variety of techniques for detecting such motion can be employed by the motion detection logic 182. For example, motion detection logic 182 analyzes low-resolution frames from imaging module 115 to detect a scene change. In one such embodiment, motion detection logic 180 sums the absolute value of pixel differences between two or more low-resolution frames to detect the scene change. In some embodiments, this technique involves blocking the digital frames into 8×8 pixel blocks or 16×16 pixel blocks. Absolute pixel differences between frames may be summed for each of a number of spatial offsets in a neighborhood surrounding each block to produce a matrix of such differences. A motion vector indicating how the camera or the scene shifts spatially from one frame to another then can be derived from this matrix of differences. When the vector exceeds a predetermined threshold, a scene change may be assumed to have occurred. In other embodiments, the mean squared error may be used to compute the metric of motion instead of the absolute value of pixel differences.

In another embodiment, motion detection logic 182 converts the low-resolution frames to the Y,C_{b},Cᵣ color space (luminance and two chrominance difference components). Using the Y (luminance) component, motion detection logic 182 computes an aggregate scene brightness for each low-resolution analysis frame. The aggregate scene brightness may be computed from the luminance component by a number of methods, some of which include the use of a histogram. By comparing the aggregate scene brightness of two or more low-resolution frames, motion detection logic 182 can detect motion.

In yet another embodiment, motion detection logic 182 is configured to detect a single moving element in an otherwise static scene (e.g., a person or object moving laterally with respect to digital imaging device 100). Although a literal scene change occurs in such a case (i.e., some pixels change from frame to frame), there is no need to adjust focus and exposure because the focus distance (the distance from digital imaging device 100 to the single laterally moving element) has not changed. Configuring motion detection logic 182 to detect this situation prevents unnecessary automatic fine focus and exposure adjustments in digital imaging device 100. Any of a variety of techniques for identifying a single moving element in an otherwise static scene can be employed. For example, the fraction of pixels that change from frame to frame may be determined. A high percentage of unchanged pixels indicate a single moving element in the scene. The presence of a single moving element may be confirmed through use of the techniques described above for computing a motion vector.

The low-resolution frames analyzed by motion detection logic 182 do not have to be successive. For example, motion detection logic 182 may analyze low-resolution frames that are separated by one or more intervening frames.

In some embodiments, motion data (e.g., motion vectors) is provided by the motion detection logic 182 to the stability filter 180 which processes the motion data to determine whether the digital imaging device 100 is in a stable or unstable state. A stable state is, for example, a state of the digital imaging device in which the amount of motion is below a threshold. The threshold can be fixed or programmable. An unstable state is a state in which the amount of motion is above the predetermined threshold. Hysterisis can be applied by the stability filter 180 to determine the state if desired.

In some embodiments, based on motion data from the motion detection logic 182, the stability filter 180 provides information to the event logic 190 to control when the event logic 190 is to perform the relevant event (e.g., auto-focus, auto-exposure). For example, if the stability filter 180 detects a change in state from the unstable to stable state, the stability filter 180 causes the event logic 190 to perform the relevant event. Once the event has been performed, while the digital imaging device 100 remains in the stable state, there is no need for the event logic 190 to continue performing the event. For example, once the digital imaging device 100 becomes stable, the stability filter 180 causes the event logic 190 to perform an auto-focus. Once the digital imaging device 100 is focused, there is no need to repeat the auto-focus process while the digital imaging device 100 remains in the stable state.

On the other hand, if the digital imaging device 100 transitions from the stable state to the unstable state, the current result of the previously performed event is likely no longer valid and, due to the present motion, there is little or no point in having the event logic 190 to attempt to perform another event. For example, once the event logic 190 performs an auto-focus, if the digital imaging device 100 begins to experience excessive motion and thus transitions to the unstable state, the current focus is likely no longer applicable. Due to the present motion, any further attempt to perform an auto-focus, which is stability-sensitive, is likely futile. Such attempts at performing a stability-sensitive process during an unstable state generally waste battery power, to the extent the digital imaging device 100 is battery-powered, and may be annoying to a user of the digital imaging device. Accordingly, the stability 180 asserts a signal to the event logic 190 to thereby prevent the event logic from performing the stability-sensitive event.

In some situations, the quality of the motion data (e.g., motion vectors) determined by the motion vector logic 182 is not trustworthy meaning that a vector that indicates motion in a certain direction may be falsely indicating such motion. For example, pointing the digital imaging device 100 at a white blank wall may not be able to discern any motion when there is motion, or may determine that there is motion then no motion exists (above the threshold) exists. The motion vector quality metric logic 184 provides information to the stability filter 180 that is indicative of the quality of the motion vector information determined by the motion detection logic 182. A quality metric from logic 184 thus provides an indication of the validity of the motion data from the motion detection logic 182. A quality metric indicative of high quality suggests that the motion data from motion detection logic 182 is more likely to be valid as compared to a low quality metric. In some embodiments, the quality of the motion data can be computed by way of a suitable technique such as a correlation of two or more frames of video (e.g., two successive frames). If the quality metric is indicative of a relatively high motion vector quality, then the stability filter uses the metric to adjust itself to be more responsive to establishing the digital imaging device 100 as in the stable state. On the other hand, if the quality metric is indicative of a lower motion vector quality, then the stability filter uses the metric to adjust itself to be less responsive.

In some situations, information about how the digital imaging device 100 is being used or has been used can be used previously by the stability filter 180 to control the event logic 190. For example, a user may carry the digital imaging device 100 (that is powered on) while walking. This motion can be detected by accelerometers or other such sensors mounted in or on the digital imaging device. The swinging motion of the digital imaging device in the user's hand may result in periodic episodes of stable states with unstable states in between. Because the user is walking, the user will not likely take any pictures. Thus, the digital imaging device 100 will experience periodic episodes of stable states without the device being used to take a picture. In such situations (user carrying a powered on digital image device while walking about), there is no need for the digital imaging device to perform any motion-sensitive processes such as auto-focus and auto-exposure. By way of another example, the user may have placed the digital imaging device 100 in a “quiet” mode in which the device 100 is not actively attempting to achieve focus. In such a mode, there is no benefit in the digital imaging device performing any motion-sensitive processes.

The historical use filter 186 determines and provides such information to the stability filter 180. The stability filter 180 uses the historical information from the historical use filter when determining whether the digital imaging device 100 is in a stable or unstable state. For example, if the stability filter determines that the digital imaging device 100 is in a stable state but the historical use filter 186 provides information to the stability filter from which the stability filter determines that there is no need to perform a stability-sensitive process, the stability filter may signal the event logic 190 not to perform the process.

In some embodiments, the historical use filter 186 determines how a user uses the digital imaging device 100 and affects the ability of the stability filter 180 to cause the stability-sensitive process to be performed. For example, the historical use filter 186 determines how long a user tends to dwell on a scene before acquiring an image. The historical use filter, in such embodiments, computes an average amount of dwell time per picture. If the dwell time exceeds a threshold, the historical use filter causes the stability filter 180 to be less responsive as there is more time to determine whether the scene is stable. On the other hand, a dwell time less than the threshold results in the historical use filter 186 causing the stability filter 180 to be more responsive.

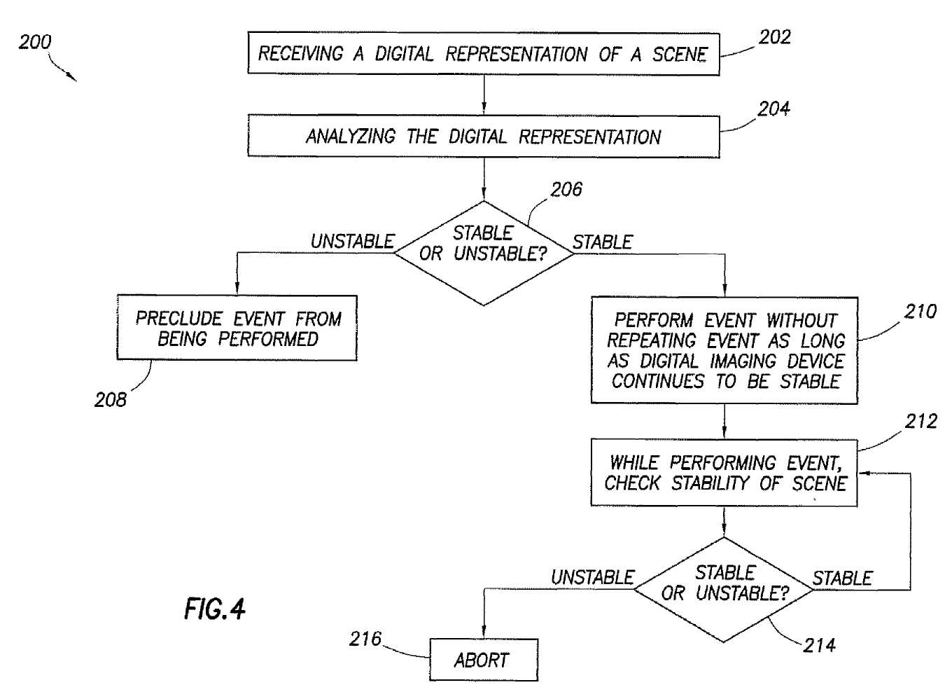

FIG. 4 provides a flowchart of at least a part of the operation of the digital imaging device. The method 200 depicted in the flow chart comprises actions 202-216. At 202, the method comprises receiving a digital representation of a scene. At 204, the method comprises analyzing the digital representation. A decision is made at 206 as to whether the scene is stable or unstable. If the scene is unstable, then at 208 the event (e.g., auto-focus) is precluded from being performed. If, however, the scene is stable, at 210 the method comprises performing the event without repeating the event as long as the digital imaging device continues to be in the stable state. While performing the event of 210, the method further comprised checking whether the digital imaging device continues to be in the stable state. As long as the state continues to be the stable state, action 210 continues to be performed. If, however, the digital imaging device 100 transitions to the unstable state while the event of 210 is being performed, the event is aborted at 216.

In accordance with at least some illustrative embodiments of the invention, the stability filter 180 can detect multiple different stable states of the digital imaging device 100. A different process can then be performed upon detection of each of the various stable states. For example, auto-exposure may be performed at a first stable state and auto-focus at a second stable state. In some embodiments, the various stable states may be differentiated with respect to time. That is, the first stable state is a state for which the digital imaging devices has been stable for a first threshold amount of time, while a second stable state is a state for which the digital imaging devices has been stable for a second threshold amount of time. The second threshold amount of time may be longer than the first threshold amount of time. More than two such stable states are possible.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
determining whether a digital imaging device is in a stable state or an unstable state;
causing an event to be performed upon said digital imaging device transitioning from the unstable state to the stable state and precluding said event from being performed while said digital imaging device is in the unstable state.

2. The method of claim 1 wherein causing said event to be performed comprises causing a stability-sensitive event to be performed.

3. The method of claim 1 wherein causing said event to be performed comprises causing an event to be performed selected from a group consisting of auto-focus and auto-exposure.

4. The method of claim 1 further comprising, after the event is performed while the digital imaging device is in the stable state, thereafter precluding said event from again being performed as long as said digital imaging continues to be in the stable state.

5. The method of claim 1 wherein causing said event to be performed also comprises using digital imaging device usage information.

6. The method of claim 5 wherein said digital imaging device usage information comprises information selected from a group consisting of a mode of operation in which a user has placed the digital imaging device and a frequency of how often the user takes a picture relative to how often the digital imaging device is in the stable state.

7. The method of claim 1 wherein determining whether the digital imaging device is in the stable state or unstable state comprises using a motion vector quality metric.

8. The method of claim 1 further comprising aborting said event if, while said event is being performed, said digital imaging device transitions to the unstable state.

9. The method of claim 1 further comprising aborting said event if, while said event is being performed in a first state, said digital imaging device transitions to a state of less stability than said first state.

10. The method of claim 1 wherein determining whether the digital imaging device is in the stable state or unstable state comprises determining multiple levels of stability states and wherein causing said event to be performed comprises causing a different event to be performed when said digital imaging device achieves each level of stability state.

11. The method of claim 10 wherein auto-exposure is performed at a first level stability state and auto-focus is performed at a second level stability state.

12. A digital imaging device, comprising:
an imaging module that converts optical images to digital images;
image processing logic coupled to said imaging module, said image processing logic determines whether the digital imaging device is in a stable state or an unstable state and causes an event to be performed upon said digital imaging device transitioning from the unstable state to the stable state and precludes said event from being performed if said digital imaging device is in the unstable state.

13. The digital imaging device of claim 12 further comprising event logic coupled to a stability filter, wherein said stability filter provides a signal to said event logic to perform said event upon the digital imaging device transitioning to the stable state.

14. The digital imaging device of claim 12 wherein said image processing logic further comprises a historical use filter that determines at least one of a mode in which said digital imaging device is set and a frequency of how often a user takes a picture relative to how often the digital imaging device is in the stable state.

15. The digital imaging device of claim 12 wherein said image processing logic further comprises motion vector quality metric logic that provides an indication of a quality associated with an indication of motion of the digital imaging device.

16. The digital imaging device of claim 12 wherein said event comprises a stability-sensitive event.

17. The digital imaging device of claim 12 said event comprises an event selected from a group consisting of auto-focus and auto-exposure.

18. The digital imaging device of claim 12 wherein said image processing logic precludes said event from being performed after the event is performed upon the digital imaging device transitioning from the unstable state to the stable state as long as said digital imaging continues to be in the stable state.

19. The digital imaging device of claim 12 wherein said image processing logic comprises a usage filter that determines usage information pertaining to said digital imaging device, said image processing logic using said usage information to cause said event to be performed.

20. The digital imaging device of claim 19 wherein said usage information comprises information selected from a group consisting of a mode of operation in which a user has placed the digital imaging device and a frequency of how often the user takes a picture relative to how often the digital imaging device is in the stable state.

21. The digital imaging device of claim 11 wherein said image processing logic comprises a motion vector quality metric logic that computes a quality metric that indicates a quality of a motion vector associated with said digital imaging device.

22. The digital imaging device of claim 12 wherein said image processing logic aborts said event if, while said event is being performed, said image processing logic determines that the digital imaging device has transitioned to the unstable state.

23. The digital imaging device of claim 12 wherein said image processing logic aborts said event if, while said event is being performed in a first state, said image processing logic determines that the digital imaging device has transitioned to a state of lower stability than said first state.

24. The digital imaging device of claim 12 wherein the image processing logic determining whether the digital imaging device is in the stable state or unstable state comprises said image processing device determining multiple levels of stability states and causing said event to be performed comprises said image processing logic causing a different event to be performed when said digital imaging device achieves each level of stability state.
